(19) United States
(12) Patent Application Publication
(10) Pub. No.: US 2026/0156335 A1
(43) Pub. Date: Jun. 4, 2026

(54) METHODS AND DEVICES FOR IMAGE ACQUISITION

(71) Applicant: ZHEJIANG DAHUA TECHNOLOGY CO., LTD., Hangzhou, Zhejiang (CN)

(72) Inventors: Fengjiao DONG, Hangzhou (CN); Naiying DING, Hangzhou (CN); Hongxing DING, Hangzhou (CN); Yinhui XU, Hangzhou (CN); Liang XU, Hangzhou (CN); Fengxi FAN, Hangzhou (CN); Wenxing HE, Hangzhou (CN); Tengfei JI, Hangzhou (CN); Jinfu HUANG, Hangzhou (CN)

(73) Assignee: ZHEJIANG DAHUA TECHNOLOGY CO., LTD., Hangzhou, Zhejiang (CN)

(21) Appl. No.: 19/495,803

(22) PCT Filed: Jun. 29, 2023
(86) PCT No.: PCT/CN2023/103746

§ 371 Date: Dec. 22, 2025

(30) Foreign Application Priority Data
Apr. 25, 2023 (CN) 202310462435.7

(51) Int. Cl. H04N 23/23; H04N 23/56

(52) U.S. Cl. CPC H04N 23/23; H04N 23/56

(57) ABSTRACT

The present disclosure provides a method and a device for image acquisition. The method includes: in response to a first acquisition instruction, obtaining at least one image of interior of a vehicle through a filter under a condition of irradiation of an infrared xenon lamp, wherein the filter includes an infrared band-pass characteristic.

### CROSS-REFERENCE TO RELATED APPLICATION

This application claims the priority of Chinese Patent Application No. 202310462435.7 filed on Apr. 25, 2023, the entire contents of which are incorporated herein by reference.

### TECHNICAL FIELD

The present disclosure relates to the field of image technology, and in particular, to a method and a device for image acquisition.

### BACKGROUND

Nowadays, the vehicle capture technology is widely used in various aspects of life. For example, various scenarios in intelligent transportation require the capture of traffic violations; and capturing the face of people inside the vehicle is necessary for identification in public roads, community entrances and exits, and other areas. However, the currently commonly used vehicle capture manners tend to produce serious light pollution, and cause glare to drivers, affecting driving safety. Moreover, the quality of the captured images needs to be improved.

Therefore, it is desirable to propose a method and a device for image acquisition that can reduce light pollution, solve the problem of glare, and improve the clarity of the captured images.

### SUMMARY

One or more embodiments of the present disclosure provides a method for image acquisition. The method includes: in response to a first acquisition instruction, obtaining at least one image of interior of a vehicle through a filter under a condition of irradiation of an infrared xenon lamp, wherein the filter includes an infrared band-pass characteristic.

In some embodiments, a difference between a first transmittance and a second transmittance of the filter may be greater than 40%, the first transmittance being a transmittance of the filter for light in a first wave band, and the second transmittance being a transmittance of the filter for light in a second wave band.

In some embodiments, the first wave band may be below 650 nm or above 900 nm, and the first transmittance may be less than or equal to 5%; and the second wave band may be between 710 nm-770 nm, and the second transmittance may be greater than 45%.

In some embodiments, a proportion of spectral energy emitted by the infrared xenon lamp in a third wave band may be greater than 90%, and the third wave band may be between 710 nm-1000 nm; and a proportion of the spectral energy emitted by the infrared xenon lamp in a fourth wave band may be greater than 40%, and the fourth wave band may be between 720 nm-750 nm.

In some embodiments, the filter may further include a polarization characteristic.

In some embodiments, the method may further include: determining a polarization angle of the filter based on at least one of environmental data, data of a window on the vehicle, or polarization data of the filter; and adjusting a position of the filter based on the polarization angle.

In some embodiments, determining the polarization angle of the filter based on at least one of the environmental data, the data of the window on the vehicle, or the polarization data of the filter may include: obtaining a first image by adjusting, based on the environmental data, the filter to a first polarization angle; obtaining a second image by adjusting the filter to a second polarization angle; comparing a first clarity of the first image and a second clarity of the second image; and determining the polarization angle of the filter based on the comparison.

In some embodiments, the method may further include adjusting a characteristic of the filter based on environmental data.

In some embodiments, adjusting the characteristic of the filter based on the environmental data may include: in response to determining that the environmental data does not satisfy a preset condition, adjusting the characteristic of the filter to a first characteristic which includes the infrared band-pass characteristic; or in response to determining that the environmental data satisfies the preset condition, adjusting the characteristic of the filter to a second characteristic which includes the infrared band-pass characteristic and a polarization characteristic.

In some embodiments, the method may further include: in response to a second acquisition instruction, obtaining two or more frames of images; and determining external information of the vehicle based on the two or more frames of images.

One or more embodiments of the present disclosure provides a method for determining a wave band of a filter. The filter is used for a camera device to obtain at least one image of interior of a vehicle under a condition of irradiation of an infrared xenon lamp. The method includes: obtaining a plurality of candidate wave bands; for each of the plurality of candidate wave bands, obtaining imaging brightness of a window on the vehicle and imaging brightness of the interior of the vehicle under the candidate wave band; and determining a brightness difference of the candidate wave band between the imaging brightness of the window on the vehicle and the imaging brightness of the interior of the vehicle under the candidate wave band; and determining, based on the brightness differences of the plurality of candidate wave bands, a first wave band and a second wave band of the filter. A difference between a first transmittance and a second transmittance of the filter is greater than 40%, the first transmittance is a transmittance of the filter for light in the first wave band, and the second transmittance is a transmittance of the filter for light in a second wave band.

In some embodiments, for one of the brightness differences, the brightness difference may be determined based on a reflectivity of the window, a transmittance of the window, and a reflectivity of the interior of the vehicle.

One of the embodiments of the present disclosure provides a system for image acquisition. The system includes a filter and a camera device. The filter is used for the camera device to obtain at least one image of interior of a vehicle under a condition of irradiation of an infrared xenon lamp; and the filter includes an infrared band-pass characteristic.

In some embodiments, a difference between a first transmittance and a second transmittance of the filter may be greater than 40%, the first transmittance being a transmittance of the filter for light in a first wave band, and the second transmittance being a transmittance of the filter for light in a second wave band.

In some embodiments, the first wave band may be below 650 nm or above 900 nm, and the first transmittance may be less than or equal to 5%; and the second wave band may be between 710 nm-770 nm, and the second transmittance may be greater than 45%.

In some embodiments, a proportion of spectral energy emitted by the infrared xenon lamp in a third wave band may be greater than 90%, and the third wave band may be between 710 nm-1000 nm; and a proportion of the spectral energy emitted by the infrared xenon lamp in a fourth wave band may be greater than 40%, and the fourth wave band may be between 720 nm-750 nm.

In some embodiments, the filter may further include a polarization characteristic.

In some embodiments, a position of the filter is adjusted based on a polarization angle of the filter which may be determined based on at least one of environmental data, data of a window on the vehicle, or polarization data of the filter.

In some embodiments, a characteristic of the filter may be adjusted based on environmental data.

One of the embodiments of the present disclosure provides a system for determining a wave band of a filter. The filter is used for a camera device to obtain at least one image of interior of a vehicle under a condition of irradiation of an infrared xenon lamp. The system includes: at least one storage device including a set of instructions; and at least one processor configured to communicate with the at least one storage device, wherein when executing the set of instructions, the at least one processor is configured to direct the system to perform operations including: obtaining a plurality of candidate wave bands; for each of the plurality of candidate wave bands, obtaining imaging brightness of a window on the vehicle and imaging brightness of the interior of the vehicle under the candidate wave band; and determining a brightness difference of the candidate wave band between the imaging brightness of the window on the vehicle and the imaging brightness of the interior of the vehicle under the candidate wave band; and determining, based on the brightness differences of the plurality of candidate wave bands, a first wave band and a second wave band of the filter, wherein a difference between a first transmittance and a second transmittance of the filter is greater than 40%, the first transmittance is a transmittance of the filter for light in the first wave band, and the second transmittance is a transmittance of the filter for light in a second wave band.

### BRIEF DESCRIPTION OF THE DRAWINGS

FIG. 1 is a schematic diagram illustrating an exemplary application scenario for image acquisition according to some embodiments of the present disclosure;

FIG. 2 is a schematic diagram illustrating an exemplary camera device according to some embodiments of the present disclosure;

FIG. 3 is a flowchart illustrating an exemplary process for determining a polarization angle of a filter based on environmental data according to some embodiments of the present disclosure;

FIGS. 4A and 4B are schematic diagrams illustrating exemplary positions of a filter according to some embodiments of the present disclosure;

FIG. 5 is a flowchart illustrating an exemplary process for adjusting a characteristic of a filter based on environmental data according to some embodiments of the present disclosure;

FIG. 6 is a schematic diagram illustrating an exemplary process for adjusting a characteristic of a filter according to some embodiments of the present disclosure;

FIG. 7 is a flowchart illustrating an exemplary process for switching a filter plate according to some embodiments of the present disclosure; and

FIG. 8 is a block diagram illustrating an exemplary processor according to some embodiments of the present disclosure.

### DETAILED DESCRIPTION

The drawings that need to be used in the description of the embodiments will be briefly introduced below. The drawings do not represent all embodiments.

As used herein, “system”, “device”, “unit”, and/or “module” is a method used to distinguish different components, elements, parts, sections, or assemblies of different classes. These words may be replaced by other expressions if they serve the same purpose.

As indicated in the present disclosure and claims, the terms “a”, “an”, “one”, and/or “the” are not specific to the singular and may include the plural unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

When the operations performed are described step by step in the embodiments of the present disclosure, unless otherwise specified, the order of the steps may be changed, the steps may be omitted, and other steps may also be included in the operation process.

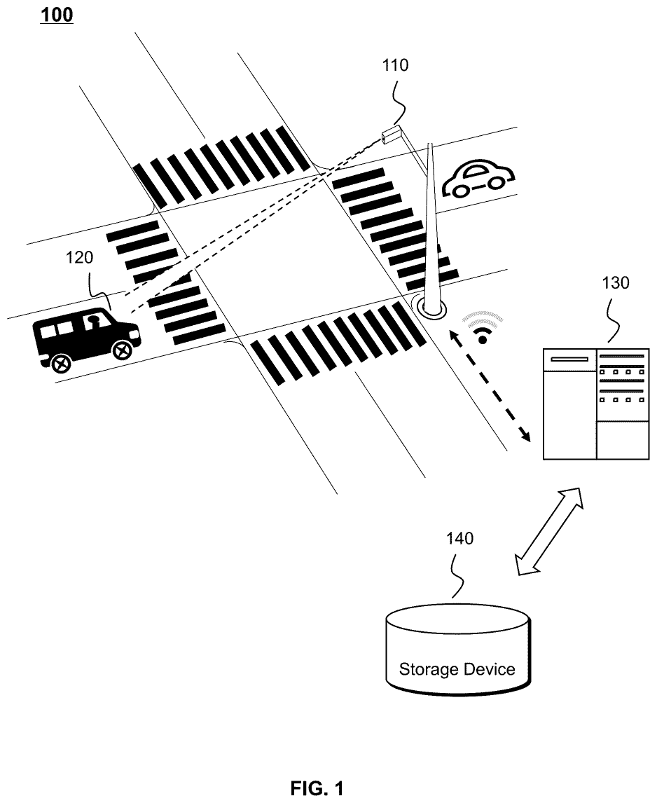

FIG. 1 is a schematic diagram illustrating an exemplary application scenario for image acquisition according to some embodiments of the present disclosure. As shown in FIG. 1, in an application scenario 100, there may be a camera device 110 and a captured vehicle 120. The application scenario 100 may further include a processor 130 and a storage device 140 related to the camera device 110.

The camera device 110 refers to a device for capturing images. In some embodiments, the camera device 110 may be disposed on a road for capturing images of people inside a vehicle. The camera device 110 may also be used for other purposes.

The captured vehicle 120 refers to a vehicle to be captured. The captured vehicle 120 may include various types of vehicles. There may be one or more captured vehicles 120. The camera device 110 hopes to be able to obtain images of people inside the captured vehicle 120.

The processor 130 may process data and/or information obtained from the camera device 110 and/or the storage device 140. In some embodiments, the processor 130 may process data obtained from the camera device 110 to generate an acquisition instruction (including at least one of a first acquisition instruction and a second acquisition instruction). In some embodiments, the processor 130 may process images obtained from the camera device 110 to identify abnormal information (e.g., an irregular driving behavior, a suspicious person, etc.).

In some embodiments, the processor 130 may include one or more processing engines (e.g., a single-chip processing engine or a multi-chip processing engine). Merely by way of example, the processor 130 may include a central processing unit (CPU), a graphics processing unit (GPU), a digital signal processor (DSP), a microprocessor, or the like, or any combination thereof.

The storage device 140 may store data, instructions (e.g., the acquisition instruction), and/or any other information. In some embodiments, the storage device 140 may store data obtained from the camera device 110 and/or the processor 130. In some embodiments, the storage device 140 may store data and/or instructions that the processor 130 may execute or use to perform exemplary processes described in the present disclosure.

In some embodiments, the storage device 140 may be a part of the processor 130. In some embodiments, the storage device 140 may be independent from the processor 130 and directly or indirectly connected to the processor 130.

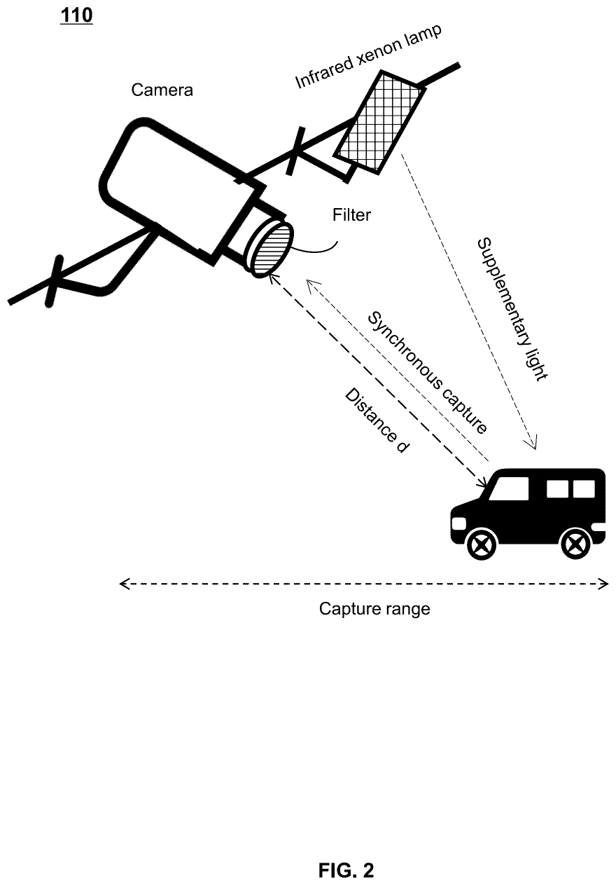

FIG. 2 is a schematic diagram illustrating an exemplary camera device according to some embodiments of the present disclosure.

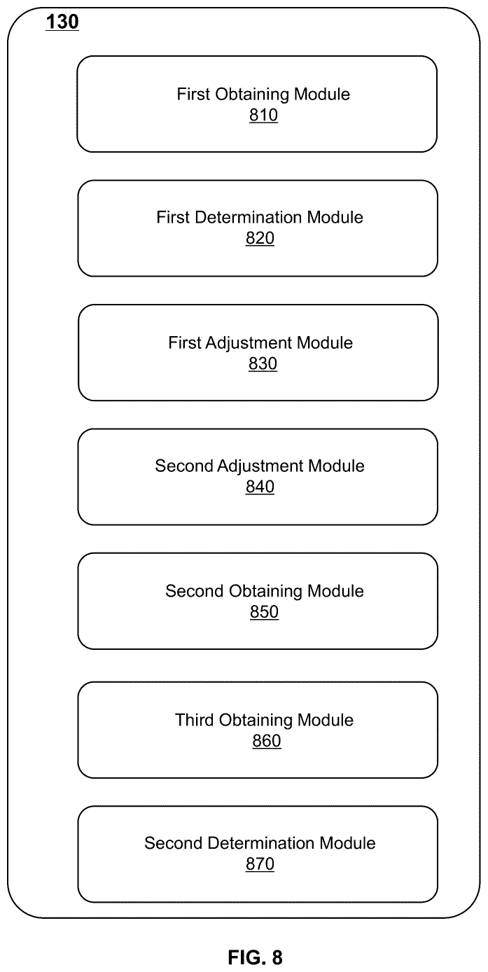

In some embodiments, in response to a first acquisition instruction, a first obtaining module 810 may obtain at least one image of interior of a vehicle through a filter under a condition of irradiation of an infrared xenon lamp. The filter may include an infrared band-pass characteristic. More details regarding the first obtaining module 810 can be found elsewhere in the present disclosure (e.g., the description in connection with FIG. 8).

In some embodiments, the processor 130 may generate the first acquisition instruction based on a distance between the camera device 110 and the captured vehicle 120. As shown in FIG. 2, a distance measuring device (not shown in FIG. 2) may be built into a camera (e.g., the camera device 110) and measure a distance d between the camera and the vehicle (e.g., the captured vehicle 120) in real-time. When the distance d satisfies a distance condition, the processor 130 may generate a first acquisition instruction.

In some embodiments, the processor 130 may generate the first acquisition instruction when judging that the vehicle enters a capture range. As shown in FIG. 2, the capture range may be artificially defined in advance, and a sensing device (not shown in FIG. 2) may be deployed at a boundary of the capture range. When the sensing device senses that a vehicle enters the capture range, the processor 130 may generate a first acquisition instruction.

The infrared xenon lamp may play a role of supplementary light in the capture.

In some embodiments, the infrared xenon lamp may be integrated into the camera device 110. In some embodiments, as shown in FIG. 2, the infrared xenon lamp may be disposed near the camera device 110.

In some embodiments, a proportion of spectral energy emitted by the infrared xenon lamp in a third wave band may be greater than 90%, and the third wave band may be between 710 nm-1000 nm. In some embodiments, a proportion of spectral energy emitted by the infrared xenon lamp in a fourth wave band may be greater than 40%, and the fourth wave band may be between 720 nm-750 nm.

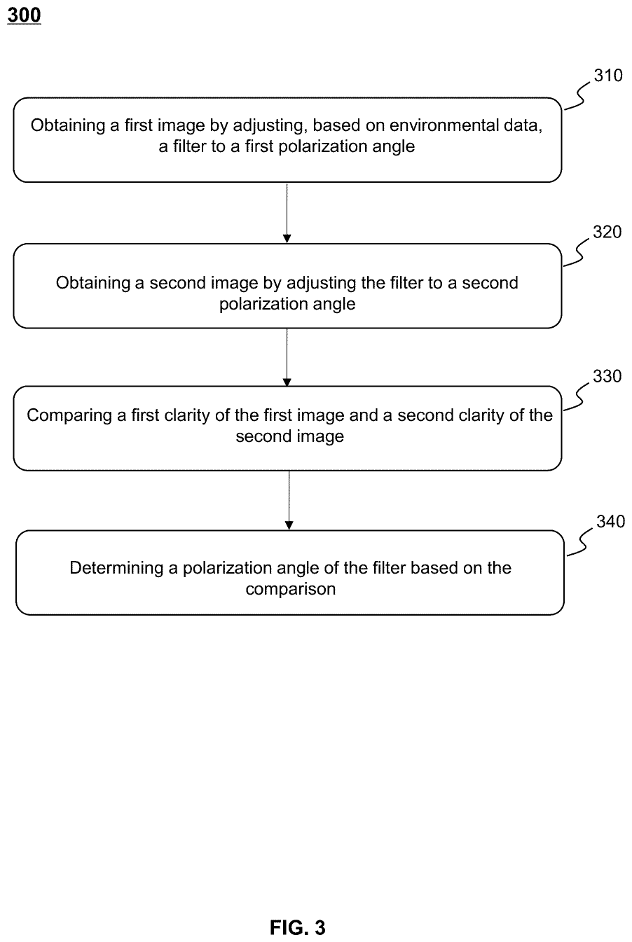

In some embodiments, an irradiance of the infrared xenon lamp may be adjusted. In some embodiments, the processor 130 may determine a minimum irradiance of the infrared xenon lamp through a preset algorithm based on environmental data and a capture distance. More details regarding the environmental data may be found elsewhere in the present disclosure (e.g., the description in connection with FIG. 3).

The capture distance refers to a distance between the camera device 110 and the vehicle during a capturing process. In some embodiments, the capture distance may be obtained by various distance-measuring devices (e.g., a rangefinder, etc.). In some embodiments, the processor 130 may predict the capture distance based on a position and speed of the vehicle in a previous image and a time interval between two successive captures. The time interval between two successive captures may be preset.

In some embodiments, the preset algorithm for determining the minimum irradiance of the infrared xenon lamp may include database matching or the like. The processor 130 may construct an irradiance vector based on the environmental data and the capture distance, determine a reference vector with a largest similarity to the irradiance vector, and designate an irradiance of the infrared xenon lamp corresponding to the reference vector as the minimum irradiance of the infrared xenon lamp during the current capture. The similarity may be determined based on a vector distance between the reference vector and the irradiance vector. The smaller the vector distance, the greater the similarity. In some embodiments, the vector distance may include a cosine distance or the like.

In some embodiments, the preset algorithm may include an irradiance determination model. The irradiance determination model may be a neural network (NN) or other machine learning models.

In some embodiments, an input of the irradiance determination model may include the environmental data and the capture distance, and an output of the irradiance determination model may include the minimum irradiance of the infrared xenon lamp.

In some embodiments, the irradiance determination model may be trained based on historical data. For example, training samples for training the irradiance determination model may include sample environmental data and a sample capture distance. A label may be a minimum irradiance of the infrared xenon lamp used in capturing an image satisfying a clarity condition under a sample condition. In some embodiments, the processor 130 may capture images using infrared xenon lamps with different irradiances under a condition of the sample environmental data and the sample capture distance, and designate the minimum irradiance of the infrared xenon lamp used in capturing the image satisfying the clarity condition as the label.

In some embodiments, the preset algorithm may also include a fitting algorithm. For example, the processor 130 may fit a relationship between the environmental data, the capture distance, and the minimum irradiance of the infrared xenon lamp through the fitting algorithm to obtain a calculation formula and process the environmental data and the capture distance based on the calculation formula to determine the minimum irradiance under the environmental data and the capture distance.

In some embodiments, the processor 130 may adjust the irradiance of the infrared xenon lamp based on an actual temperature of the infrared xenon lamp. For example, when the infrared xenon lamp continues to work, resulting in a temperature greater than a temperature threshold, the processor 130 may properly reduce the irradiance of the infrared xenon lamp.

In some embodiments, the processor 130 may adjust the irradiance of the infrared xenon lamp based on the environmental data. For example, when the weather temperature in the environmental data is high, the processor 130 may properly reduce the irradiance of the infrared xenon lamp.

In some embodiments of the present disclosure, the minimum irradiance of the infrared xenon lamp may be determined based on the environmental data and the capture distance, which can save resources on a basis of ensuring that the clarity of the obtained image satisfies the clarity condition. The irradiance may be adjusted according to the weather temperature or the actual temperature of the infrared xenon lamp, which can properly reduce the irradiance when the temperature is high, thereby avoiding damage to the infrared xenon lamp due to an excessive temperature and extending the service life of the infrared xenon lamp.

The filter refers to a device that transmits and filters light. Filters with different characteristics produces different degrees of filtering effects on the light in different wave bands. A typical filter may be a thin sheet. The filter may also be a combination of a plurality of thin sheets or be realized in other ways.

In some embodiments, the filter may include an infrared band-pass characteristic. The infrared band-pass characteristic refers to a property that the filter has different transmittances for the light in different wave bands. More details regarding the infrared band-pass characteristic can be found elsewhere in the present disclosure (e.g., the description in connection with FIGS. 3-6).

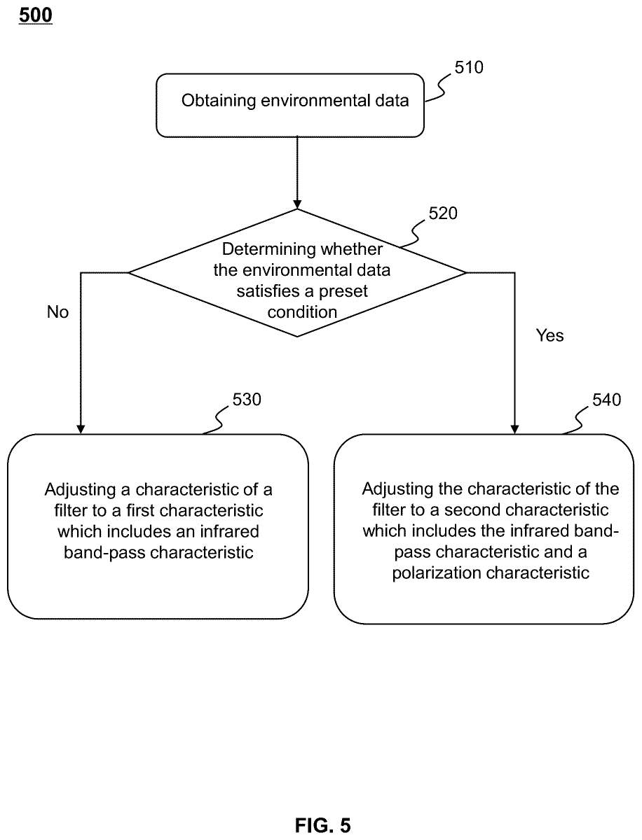

In some embodiments, the filter may include an all-pass characteristic. The all-pass characteristic refers to a property that the filter has a relatively high transmittance to the light in a wave band with a relatively wide range. More details regarding the all-pass characteristic can be found elsewhere in the present disclosure (e.g., the description in connection with FIG. 5).

In some embodiments, as shown in FIG. 2, the filter may be disposed on lens of the camera device 110. The filter may also be disposed on the camera device 110 in other ways. In some embodiments, the characteristic of the filter may be adjusted. More details regarding the characteristic can be found elsewhere in the present disclosure (e.g., the description in connection with FIGS. 3-6).

In some embodiments of the present disclosure, under the supplementary light of the infrared xenon lamp, the image of the people inside the vehicle may be obtained through the filter, which can not only reduce light pollution and avoid causing glare to the people inside the vehicle, but also improve the clarity of the captured image.

In some embodiments, a difference between a first transmittance and a second transmittance of the filter is greater than 40%. The first transmittance is a transmittance of the first transmittance for light in a first transmittance, and the first transmittance is a transmittance of the first transmittance for light in a first transmittance.

The transmittance in the wave band in the present disclosure refers to an average transmittance for light in the wave band.

The first wave band refers to a wave band of light that needs to be filtered by the filter, and the second wave band refers to a wave band of light that needs to pass through the filter.

In some embodiments, the first wave band is below 650 nm or above 900 nm, and the first transmittance is less than or equal to 5%; and the second wave band is between 710 nm-770 nm, and the second wave band is greater than 45%.

In some embodiments, the first wave band is below 650 nm, and the first transmittance is less than or equal to 2%. In some embodiments, the first wave band is above 900 nm, and the first transmittance is less than or equal to 5%. In some embodiments, the second wave band is between 710 nm-770 nm, and the second transmittance is greater than 45%.

In some embodiments, the first wave band is below 650 nm or above 900 nm, and the first transmittance is less than or equal to 5%. In some embodiments, the second wave band is between 710 nm-770 nm, and the second transmittance is greater than 92%.

In some embodiments, the first wave band and the second wave band may be determined based on historical experience. For example, a second determination module 870 may obtain an image with a highest resolution among historically captured images, and designate a first and second wave band corresponding to a filter used when capturing the image as the first and second wave bands which need to be determined during the current capture. The first wave band and the second wave band may also be determined in other ways. More details regarding the second determination module 870 can be found elsewhere in the present disclosure (e.g., the description in connection with FIG. 8).

In some embodiments, the second determination module 870 may obtain a plurality of candidate wave bands; for each of the plurality of candidate wave bands, the second determination module 870 may obtain imaging brightness of the window on the vehicle and imaging brightness of the interior of the vehicle under the candidate wave band; the second determination module 870 may determine a brightness difference of the candidate wave band between the imaging brightness of the window on the vehicle and the imaging brightness of the interior of the vehicle under the candidate wave band; and the second determination module 870 may determine the first wave band and the second wave band of the filter based on the brightness differences of the plurality of candidate wave bands. In some embodiments, the difference between the first transmittance and the second transmittance of the filter is greater than 40%, the first transmittance is the transmittance of the filter for the light in the first wave band, and the second transmittance is the transmittance of the filter for the light in the second wave band.

In some embodiments, for one of the brightness differences, the brightness difference may be determined based on a reflectivity of the window, a transmittance of the window, and a reflectivity of the interior of the vehicle.

In some embodiments, the candidate wave bands may be determined based on historical data. For example, the processor 130 may obtain the image satisfying the clarity condition among the historically captured images, and designate a second wave band of the filter used in capturing the image satisfying the clarity condition as a candidate wave band.

The greater the brightness difference under a certain candidate wave band, the clearer the in-vehicle imaging under the candidate wave band. In some embodiments, the second determination module 870 may determine a candidate wave band with a largest brightness difference as the second wave band, and determine a wave band in the spectrum other than the second wave band as the first wave band based on the brightness differences under the plurality of candidate wave bands.

In some embodiments, the brightness difference may be determined by the following formulas (1)-(3):

$$N = ( W s + W x ) \times Tc \times Rn \times Tc \times Ti \times Rs \qquad ( 1 )$$

$$M = ( Ws + Wx ) \times Rc \times Ti \times Rs \qquad ( 2 )$$

$$β = N / M \qquad ( 3 )$$

where N denotes a response function of the interior of the vehicle, M denotes a response function of the window, β denotes the brightness difference, Ws denotes solar spectral energy of the candidate wave band, Wx denotes the spectral energy of the infrared xenon lamp, Rc denotes the reflectivity of the window, Rn denotes the reflectivity of the interior of the vehicle, Tc denotes the transmittance of the window, Ti denotes the transmittance of the filter, and Rs denotes response parameters of a sensor. In the calculation process, Ws, Wx, Ti, and Rs may be reduced. Therefore, the parameters affecting β are Rc, Rn, and Tc. β may be one of ways of expressing the brightness difference, and the brightness difference may also be obtained and expressed in other ways.

In some embodiments, the reflectivity Rc of the window and the transmittance Tc of the window may be determined based on historical data. For example, the processor 130 may obtain a historically captured image, identify a vehicle type in the image through a vehicle type identification model, query and count reflectivities of windows and transmittances of the windows of different types of vehicles according to the vehicle type, and determine the reflectivity Rc of the window and the transmittance Tc of the window based on the statistical data. Details regarding the vehicle type identification model may be found elsewhere in the present disclosure (e.g., the description in connection with FIG. 3).

In some embodiments, the reflectivity Rn of the interior of the vehicle may be determined based on historical data. For example, the processor 130 may obtain historically captured images, determine and count face data inside different vehicles through various image analysis techniques, and determine the reflectivity Rn of the interior of the vehicle based on statistical data.

In some embodiments of the present disclosure, by calculating the brightness differences under different wave bands, a wave band with clearer imaging in the vehicle may be accurately determined, and the brightness difference may be calculated based on the reflectivity of the window, the transmittance of the window, and the reflectivity of the interior of the vehicle, which can ensure that the calculation result is more in line with an actual application scenario.

In some embodiments, in response to a second acquisition instruction, a second obtaining module 850 may obtain two or more frames of images. Details regarding the second obtaining module 850 may be found elsewhere in the present disclosure (e.g., the description in connection with FIG. 8).

In some embodiments, the two or more frames of images may be two or more frames of images obtained continuously through the same filter. In some embodiments, the second obtaining module 850 may directly obtain the two or more frames of images using the current filter.

In some embodiments, a third obtaining module 860 may obtain external information of the vehicle based on the two or more frames of images. Details regarding the third obtaining module 860 may be found elsewhere in the present disclosure (e.g., the description in connection with FIG. 8).

The external information of the vehicle refers to information related to an external situation of the captured vehicle. The external information of the vehicle may include a license plate position.

In some embodiments, the third obtaining module 860 may determine a license plate position in a next capture using a preset algorithm based on the two or more frames of images, the position of the captured vehicle in the two or more frames of images, and an actual position of the captured vehicle in the next capture.

In some embodiments, the third obtaining module 860 may predict the actual position of the captured vehicle in the next capture based on a position of the captured vehicle in the last image of the two or more frames of images, the speed of the captured vehicle, and a time interval between the current capture and the next capture.

In some embodiments, the preset algorithm may include a license plate position identification model. The license plate position identification model may be a Convolution Neural Network (CNN) model, or other machine learning models.

In some embodiments, an input of the license plate position identification model may include the two or more frames of images, the position of the captured vehicle in the two or more frames of images, and the actual position of the captured vehicle in the next capture, and an output of the license plate position identification model may include the license plate position in the next capture.

In some embodiments, the license plate position identification model may be trained based on historical data. For example, training samples for training the license plate position identification model may include two or more frames of sample images, a position of a captured vehicle in the two or more frames of sample images, and a sample actual position of the captured vehicle in a next capture. A label corresponding to the training sample may be an actual license plate position in the next capture.

In some embodiments, the preset algorithm may include other algorithms. For example, the third obtaining module 860 may determine the license plate position through projection analysis of the image in horizontal and vertical directions according to a count of times with license plate characters and the background appearing alternately in the two or more frames of images using a projection analysis manner. As another example, the third obtaining module 860 may determine the license plate position by detecting and merging connected domains of the characters according to the license plate characters in the two or more frames of images using a connected domain analysis manner.

In some embodiments, the third obtaining module 860 may determine a position of an added grille according to the license plate position. The position of the added grille is located below the license plate position.

In some embodiments of the present disclosure, by obtaining the two or more frames of images and determining the license plate position based on the two or more frames of images, the position of the added grille can be accurately determined. Blocking the light below the license plate position through the added grille can improve the clarity of the interior of the vehicle and the clarity of the license plate in the captured image.

In some embodiments, the filter may also include a polarization characteristic.

The polarization characteristic refers to a property of the filter to filter polarization of the light.

The polarization angle refers to an angle of polarization of light that may pass.

When the people inside the vehicle is captured, reflected light of the window on the vehicle may interfere with imaging. The reflected light may have a certain polarization direction. When the polarization angle of the filter is appropriate, the filter may filter out a portion or all of the reflected light of the window, thereby improving the clarity of the captured image.

During the actual capture process, due to various factors, the polarization direction of the reflected light of the window may change. The various factors may include: different directions of sunlight incident on the window surface, different inclination angles inherent in the window, etc. In some embodiments, the polarization angle of the filter may be adjusted to achieve a better filtering effect.

In some embodiments, by using the filter with the polarization characteristic, influence of the reflected light of the window on the vehicle may be reduced to improve the clarity of the image.

In some embodiments, a first determination module 820 may determine the polarization angle of the filter based on at least one of environmental data, data of a window on the vehicle, or polarization data of the filter. Details regarding the first obtaining module 820 may be found elsewhere in the present disclosure (e.g., the description in connection with FIG. 8).

The environmental data refers to information data related to the capture environment. For example, the environmental data may include environmental brightness, a light direction, a light intensity, weather data (e.g., fog data and precipitation data), etc.

In some embodiments, the environmental data may be obtained through sources such as various devices or third-party platforms. For example, the light intensity in the environmental data may be obtained through a light intensity sensor. As another example, the light intensity in the environmental data may be obtained through a meteorological platform.

The data of the window refers to information data related to the window. The data of the window may include the inclination angle of the window, the reflection direction of the window, or the like. The data of the window may also include the reflectivity of the window, a refractive index of the window, or the like.

In some embodiments, the data of the window may be obtained through a preset algorithm. For example, the type of the captured vehicle may be determined using an image identification model, and the inclination angle of the window may be determined based on the pre-stored information of the type. As another example, the reflection direction of the window may be determined based on the inclination angle of the window and the light direction. For more information about the preset algorithm, please refer to related descriptions below.

Polarization characteristic data refers to data related to the polarization characteristic of the reflected light of the window of the vehicle. For example, the polarization characteristic data may include the polarization direction of the reflected light of the window, a polarization degree of the reflected light of the window, or the like.

In some embodiments, the polarization characteristic data may be obtained by various measuring devices or other manners. For example, the polarization direction and the polarization degree of the reflected light of the window may be obtained by a polarization state measuring instrument.

In some embodiments, the first determination module 820 may process at least one of the environmental data, the data of the window on the vehicle, or the polarization data of the filter through various feasible algorithms (such as the fitting algorithm) to determine the polarization angle of the filter. More embodiments of the process for determining the polarization angle may be found elsewhere in the present disclosure (e.g., the description in connection with FIG. 3).

In some embodiments, a first adjustment module 830 may adjust the position of the filter based on the polarization angle.

In some embodiments, the first adjustment module 830 may change the polarization angle by rotating the filter. In some embodiments, for a filter having an electrically controllable characteristic of the polarization angle, the first adjustment module 830 may change the polarization angle of the filter through electrical control. The first adjustment module 830 may also change the polarization angle in other ways.

In some embodiments of the present disclosure, the polarization angle of the filter is determined based on the environmental data, the data of the window on the vehicle, and the polarization data of the filter, and the polarization angle of the filter can be dynamically adjusted according to actual capture conditions, so that the polarization angle of the filter can adapt to the actual capture conditions, thereby ensuring the clarity of the captured image.

FIG. 3 is a flowchart illustrating an exemplary process for determining a polarization angle of a filter based on environmental data according to some embodiments of the present disclosure. As shown in FIG. 3, a process 300 may include the following operations.

In operation 310, a first image may be obtained by adjusting, based on the environmental data, the filter to a first polarization angle.

The first polarization angle refers to a polarization angle before adjusting the filter when an image acquisition device starts capturing based on the environmental data. In some embodiments, the first determination module 820 may determine the first polarization angle based on the environmental data and adjust the filter to the first polarization angle. For example, the processor 130 may construct a data table based on historical environmental data and a polarization angle of a filter corresponding to the historical environmental data, and the first determination module 820 may query the data table to find historical environmental data that is the same as the current environmental data, and designate a polarization angle of a filter corresponding to the historical environmental data as the first polarization angle.

The first image refers to an image obtained by the filter at the first polarization angle.

In operation 320, a second image may be obtained by adjusting the filter to a second polarization angle.

The second polarization angle refers to a polarization angle adjusted by the filter based on the first polarization angle. In some embodiments, the second polarization angle may be determined based on the first polarization angle. For example, the first determination module 820 may determine the second polarization angle based on the first polarization angle and a preset adjustment angle. The preset adjustment angle may be determined according to the environmental data and/or the first image. For example, the stronger the light intensity in the environmental data, the more severe the reflection in the first image, and the preset adjustment angle may be increased appropriately.

The second image refers to an image obtained by the filter at the second polarization angle.

In operation 330, a first clarity of the first image and a second clarity of the second image may be compared, the first clarity may be a clarity of the first image, and the second clarity may be a clarity of the second image.

In some embodiments, the first determination module 820 may compare the first clarity and the second clarity through a clarity model. The clarity model may be a machine learning model. In some embodiments, an input of the clarity model may include the first image and the second image, and an output of the clarity model may include the comparison result.

In operation 340, the polarization angle of the filter may be determined based on the comparison result.

In some embodiments, if the second clarity is greater than the first clarity, the first determination module 820 may designate a direction from the first polarization angle to the second polarization angle as an adjustment direction to adjust the filter. In some embodiments, if the first clarity is greater than the second clarity, the first determination module 820 may designate an opposite direction from the first polarization angle to the second polarization angle as the adjustment direction to adjust the filter.

In some embodiments, the first determination module 820 may continuously adjust the position of the filter through the operations 310-340 until an image whose clarity satisfies a clarity condition is obtained and designate the polarization angle of the filter when the image is captured as the polarization angle to be determined.

In some embodiments of the present disclosure, the polarization angle of the filter is determined based on the clarity of the obtained image by constantly adjusting the position of the filter, so that the determined polarization angle can be closer to an optimal polarization angle.

In some embodiments, after the first image is obtained through the operation 310, the first determination module 820 may determine whether the first clarity satisfies the clarity condition. If the first clarity satisfies the clarity condition, the first determination module 820 may directly execute the operations 320-340 to determine the polarization angle of the filter. If the clarity condition is not satisfied, the first determination module 820 may determine an inclination angle of the window on the captured vehicle through a preset algorithm, determine a preferred adjustment angle based on the inclination angle of the window and the environmental data, and determine the polarization angle of the filter by combining the operations 320-340 based on the preferred adjustment angle.

In some embodiments, the first determination module 820 may obtain a pre-identified image when a capture distance satisfies a first distance. The first determination module 820 may adjust the filter based on the pre-identified image. In some embodiments, the first determination module 820 may obtain a new image again when the capture distance satisfies a second distance. Both the first distance and the second distance refer to distances between the vehicle and the camera device 110, and the first distance is greater than the second distance. Details regarding the capture distance may be found elsewhere in the present disclosure (e.g., the description in connection with FIG. 2).

In some embodiments, the preset algorithm may include a vehicle type identification model. The vehicle type identification model may be a Convolution Neural Network (CNN) model, or other machine learning models.

In some embodiments, an input of the vehicle type identification model may include the first image, and an output of the vehicle type identification model may include a vehicle type in the first image.

In some embodiments, the vehicle type identification model may be trained based on historical data. For example, training samples for training the vehicle type identification model may include images of vehicles of different vehicle types. A label corresponding to the training sample may be an actual type of the vehicle in the image.

In some embodiments, the processor 130 may build a database based on different vehicle types and related parameters (e.g., the inclination angle of the window, the reflectivity of the window, the refractive index of the window, etc.). In some embodiments, the first determination module 820 may match the inclination angle of the window corresponding to the vehicle type through the database based on the vehicle type output by the vehicle type identification model.

In some embodiments, the preset algorithm may include a window angle identification model. The window angle identification model may be a Convolution Neural Network (CNN) model or other machine learning models.

In some embodiments, an input of the window angle identification model may include at least one captured image, and an output of the window angle identification model may include the inclination angle of the window on the vehicle in the image. In some embodiments, when the input of the vehicle window angle identification model is a plurality of captured images, the plurality of captured images may include continuously captured images. In some embodiments, the at least one captured image input into the vehicle window angle identification model may include a plurality of vehicles, and the inclination angle of the window output by the vehicle window angle identification model is an inclination angle of a window on each of the plurality of vehicles in the image.

In some embodiments, the window angle identification model may be trained based on historical data. For example, training samples for training the window angle identification model may include at least one captured image of at least one sample vehicle. A label corresponding to the training sample is an actual inclination angle of the window on the at least one sample vehicle. In some embodiments, the label may be determined manually.

The preferred adjustment angle refers to an angle close to the optimal polarization angle of the filter. There may be a plurality of preferred adjustment angles.

In some embodiments, the first determination module 820 may determine a corresponding preferred adjustment angle using a preset algorithm based on the inclination angle of the window and the environmental data. For example, the processor 130 may obtain historical data and construct a data table based on the historical data; and the first determination module 820 may search historical data same as a current inclination angle of the window on the vehicle and current environmental data by querying the data table, and designate a polarization angle in the historical data as the preferred adjustment angle. The historical data may include a historically captured image, an inclination angle of a window on a vehicle in the image, environmental data when the image was captured, and a polarization angle of the filter when the image was captured. In some embodiments, the first determination module 820 may preferentially adjust the filter to the preferred adjustment angle, obtain an image and judge the clarity of the image. If there is an image whose clarity satisfies a clarity threshold, a preferred adjustment angle when the image is captured may be determined as the polarization angle of the filter. If there is no image whose clarity satisfies the clarity threshold, the position of the filter corresponding to an image with a highest clarity among images obtained from the preferred adjustment angle may be used as the new first position, and the polarization angle of the filter may be determined through the operations 310-340.

In some embodiments of the present disclosure, when the first image is relatively blurred, the inclination angle of the window is identified using the preset algorithm, the preferred adjustment angle is determined, and then the polarization angle of the filter is determined based on the preferred adjustment angle. On a premise of ensuring that the polarization angle of the filter is closer to the optimal polarization angle, this approach can improve processing efficiency and avoid ineffective adjustments of a motor to the filter, thereby extending a service life of the motor and the filter.

In some embodiments, the first determination module 820 may predict a polarization angle of the filter in a next capture based on a capture interval.

The capture interval refers to a time interval between a current capture time and a predicted next capture time, and the capture interval may include a capture time and an idle time. For example, the capture interval may be (t6, t7), which means that the time period t6 is the capture time and the time period t7 is the idle time within the capture interval, wherein t6 may be 20 s and t7 may be 10 s.

In some embodiments, the first determination module 820 may predict the next capture time based on a time sequence of historical capture intervals. The time sequence of the historical capture intervals refers to a sequence composed of a plurality of consecutive capture times and idle times of the historical capture intervals. In some embodiments, the first determination module 820 may predict the next capture time based on the time sequence of the historical capture intervals by means of a prediction model or vector database matching.

For example, the first determination module 820 may input the current capture time and the time sequence of the historical capture intervals into the prediction model, and an output of the prediction model may be the next capture time.

As another example, the processor 130 may construct a capture interval reference vector based on the time sequence of the historical capture intervals, construct a capture interval vector database based on a plurality of capture interval reference vectors, and construct a capture interval current vector based on the current capture time and a time sequence of a plurality of historical capture intervals. The first determination module 820 may search the capture interval vector database to determine a capture interval reference vector with a greatest similarity to the capture interval current vector and designate a next capture time corresponding to the capture interval reference vector as the predicted next capture time. The similarity may be expressed based on a vector distance between the capture interval reference vector and the capture interval current vector. The smaller the vector distance is, the greater the similarity may be. In some embodiments, the vector distance may include a cosine distance, a Euclidean distance, or the like.

In some embodiments, if the capture interval or idle time is less than a duration threshold, the capture frequency may be high, and there is no need to predict the next capture time and adjust the filter in advance.

In some embodiments, the first determination module 820 may predict the polarization angle of the filter in the next capture based on capture data of one or more previous capture intervals and adjust the filter to a position corresponding to the polarization angle during the idle time.

The capture data refers to relevant information data in the capture time. The capture data may include environmental data in the capture time, a sequence of an image and its device parameters, a position sequence of the vehicle, or the like.

The sequence of an image and its device parameters refers to a sequence composed of image data (e.g., a clarity) of at least one captured image and parameters (e.g., the polarization angle of the filter) corresponding to the device when the image is captured.

The position sequence of the vehicle refers to a sequence composed of a relative position of at least one captured vehicle to the camera device 110 and a spatial position of the at least one captured vehicle.

In some embodiments, the first determination module 820 may predict the polarization angle of the filter in the next capture based on capture data of one or more previous capture intervals through the vector database during the idle time.

In some embodiments, the processor 130 may construct a capture data reference vector based on historical capture data, construct a capture data vector database based on a plurality of capture data reference vectors, and construct a capture data current vector based on current capture data. The first determination module 820 may determine a capture data reference vector with a greatest similarity to the current capture data vector by searching the capture data vector database and designate a polarization angle of the filter in the next capture corresponding to the capture data reference vector as the polarization angle of the filter in the predicted next capture. The similarity may be expressed based on a vector distance between the capture data reference vector and the capture data current vector. The smaller the vector distance, the greater the similarity. Exemplarily, the vector distance may include a cosine distance, a Euclidean distance, or the like.

In some embodiments, the first determination module 820 may predict the polarization angle of the filter in the next capture based on the capture data of one or more previous capture intervals using a polarization direction prediction model during the idle time.

In some embodiments, the polarization direction prediction model may be a machine learning model, such as a Convolution Neural Network (CNN) model or the like.

In some embodiments, an input of the polarization direction prediction model may include the capture data of one or more previous capture intervals, and an output of the polarization direction prediction model may include the predicted polarization angle of the filter in the next capture.

In some embodiments, the polarization direction prediction model may be trained based on historical data. For example, training samples for training the polarization direction prediction model may include a plurality of sets of sample capture data. A label corresponding to the training sample may be the polarization angle used in obtaining an image whose clarity satisfies the clarity threshold based on each set of sample capture data. In some embodiments, the processor 130 may use different polarization angles to obtain images based on the each set of sample capture data and designate the polarization angle used in obtaining the image whose clarity satisfies the clarity threshold as a label of the each set. In some embodiments, the processor 130 may obtain an image whose clarity satisfies the clarity threshold based on historical data as a label and designate historical capture data corresponding to the image as the sample capture data.

In some embodiments of the present disclosure, by predicting the next capture time and polarization angle in advance during the idle time, and adjusting the filter in advance, the idle time can be fully utilized and the capture efficiency may be improved.

In some embodiments, the capture data may also include the inclination angle of the window on the captured vehicle. In some embodiments, during the idle time, the first determination module 820 may predict the polarization angle of the filter in the next capture based on the capture data of one or more previous capture intervals through the vector database or the polarization direction prediction model. The capture data may include the environmental data, the sequence of the image and its device parameters, the position sequence of the vehicle, and the inclination angle of the window on the captured vehicle.

In some embodiments of the present disclosure, when there are a plurality of captured vehicles in the image, the inclination angles of windows of the captured vehicles are taken into consideration to determine the optimal polarization angle taking into account the conditions of each vehicle to ensure overall quality of the captured image.

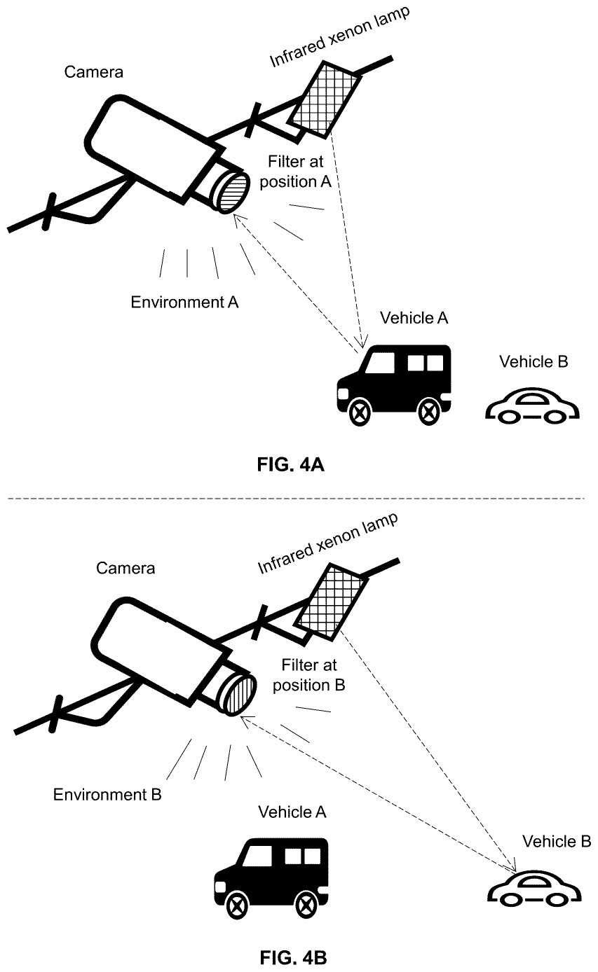

FIGS. 4A and 4B are schematic diagrams illustrating exemplary positions of a filter according to some embodiments of the present disclosure.

In some embodiments, the first adjustment module 830 may adjust a position of the filter based on a polarization angle. For example, the first adjustment module 830 may change the position of the filter by controlling a motor on the camera device 110 to rotate the filter based on the polarization angle. More details regarding the first adjustment module 830 can be found elsewhere in the present disclosure (e.g., the description in connection with FIG. 8).

As shown in FIG. 4A, when the camera device 110 captures an image of vehicle A under a condition of environment A, the filter is located at position A, and the polarization angle of the filter is suitable for vehicle A at this time. As shown in FIG. 4B, when the camera device 110 captures an image of vehicle B under a condition of environment B, since the polarization direction of reflected light of the window on vehicle B is different from that of vehicle A, the first determination module 820 may re-determine the polarization angle of the filter, and the first adjustment module 830 may adjust the filter from position A to position B based on the polarization angle. At this time, the polarization angle of the filter is suitable for vehicle B.

In some embodiments, a second adjustment module 840 may adjust a characteristic of the filter based on environmental data.

More details regarding the environmental data can be found elsewhere in the present disclosure (e.g., the description in connection with FIG. 3). More details regarding the characteristic of the filter can be found elsewhere in the present disclosure (e.g., the description in connection with FIG. 2).

In some embodiments, the processor 130 may construct a data table based on historical environmental data and a characteristic of a filter corresponding to the historical environmental data, and the second adjustment module 840 may query the data table to find historical environmental data that is the same as current environmental data and adjust a current characteristic of the filter to the characteristic of the filter corresponding to the historical environmental data. The second adjustment module 840 may also adjust the characteristic of the filter in other ways.

FIG. 5 is a flowchart illustrating an exemplary process for adjusting a characteristic of a filter based on environmental data according to some embodiments of the present disclosure. As shown in FIG. 5, a process 500 may include the following operations.

In operation 510, environmental data may be obtained.

In operation 520, whether the environmental data satisfies a preset condition may be determined.

The preset condition may include that the environmental data is greater than or equal to a brightness threshold. The preset condition may also include that the environmental data is within a preset time range (e.g., 8:00-18:00). The brightness threshold and preset time range may be set empirically.

In operation 530, in response to determining that the environmental data does not satisfy the preset condition, the characteristic of the filter may be adjusted to a first characteristic which includes an infrared band-pass characteristic.

In some embodiments, when the first characteristic is the infrared band-pass characteristic, a difference between a first transmittance and a second transmittance of a filter with the first characteristic may be greater than 87%.

In some embodiments, the first characteristic may also include an all-pass characteristic. In some embodiments, when the first characteristic is the all-pass characteristic, the transmittance of the filter with the first characteristic to a spectrum with a wavelength of 400 nm-1100 nm may be greater than 92%.

In operation 540, in response to determining that the environmental data satisfies the preset condition, the characteristic of the filter may be adjusted to a second characteristic which includes the infrared band-pass characteristic and a polarization characteristic.

In some embodiments, a difference between a first transmittance and a second transmittance of a filter with the second characteristic may be greater than 40%.

In some embodiments, in response to a determination that the environmental data does not satisfy the preset condition, the filter with the second characteristic may also be used for capture.

More details regarding the infrared band-pass characteristic, the first transmittance, and the second transmittance can be found elsewhere in the present disclosure (e.g., the description in connection with FIG. 2). More details regarding the polarization characteristic can be found elsewhere in the present disclosure (e.g., the description in connection with FIG. 3).

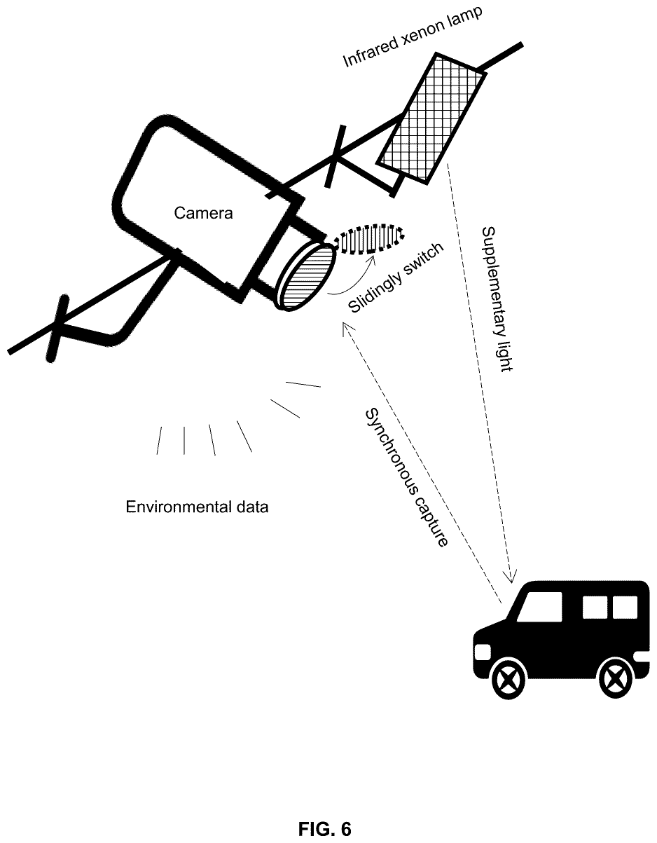

FIG. 6 is a schematic diagram illustrating an exemplary process for adjusting a characteristic of a filter according to some embodiments of the present disclosure.

In some embodiments, the second adjustment module 840 may adjust the characteristic of the filter by switching between filters with different characteristics slidingly. As shown in FIG. 6, the second adjustment module 840 may slidingly switch the filters based on the environmental data to adjust the characteristics of the filters.

In some embodiments, the second adjustment module 840 may also adjust the characteristics of the filters in other feasible ways.

In some embodiments of the present disclosure, adaptively selecting appropriate capture conditions according to environmental data can not only ensure reasonable utilization of capture resources, but also improve the quality of captured images.

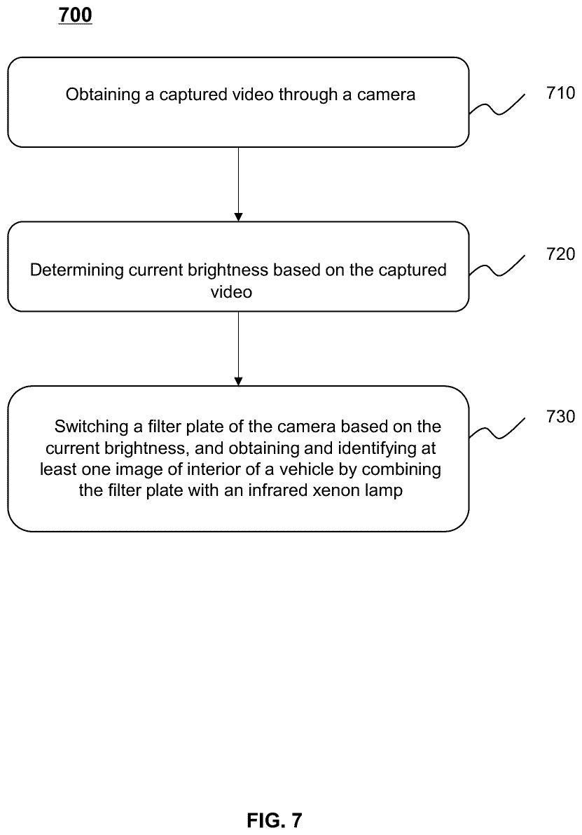

FIG. 7 is a flowchart illustrating an exemplary process for switching a filter plate according to some embodiments of the present disclosure. In some embodiments, a process 700 may be executed by the processor 130. As shown in FIG. 7, the process 700 includes the following operations.

The filter plate(s) described in FIG. 7 have the same meaning as the filter(s) described in FIGS. 1-6 and 8.

In operation 710, a captured video may be obtained through a camera.

The camera used for capturing the video may be an optical imaging device installed on the road. In some embodiments, the camera may be configured with a Complementary Metal Oxide Semiconductor (CMOS) or Charge coupled Device (CCD) imaging chip.

In operation 720, current brightness may be determined based on the captured video.

The current brightness may be brightness of current real environment.

In some embodiments, the processor 130 may process the captured video through an image analysis manner to determine the current brightness.

In operation 730, a filter plate of the camera may be switched based on the current brightness, and at least one image of interior of a vehicle may be obtained and identified by combining the filter plate with an infrared xenon lamp. More details regarding switching the filter plates (also referred as to filters) can be found elsewhere in the present disclosure (e.g., the description in connection with FIG. 5 and FIG. 6).

In some embodiments, the filter plate includes a first filter plate and a second filter plate. In some embodiments, the first filter plate may include an infrared band-pass polarization filter, and the second filter plate may include an infrared band-pass filter or an all-pass filter.

In some embodiments, in response to a determination that the current brightness is greater than or equal to a first preset threshold, the filter plate of the camera may be switched to the first filter plate. For example, in daytime, when the current brightness is greater than or equal to the first preset threshold, the first filter plate may be the infrared band-pass polarization filter. More details regarding the polarization characteristic of the filter plate (filter) can be found elsewhere in the present disclosure (e.g., the description in connection with FIG. 3 and FIG. 4).

In some embodiments, the first filter plate may be the infrared band-pass polarization filter, and a transmittance of the infrared band-pass polarization filter for a spectrum with a wavelength below 650 nm may be less than or equal to 2%, a transmittance of the infrared band-pass polarization filter for a spectrum with a wavelength of 710 nm-770 nm may be more than 45%, and a transmittance of the infrared band-pass polarization filter for a spectrum with a wavelength of 900 nm or more may be less than or equal to 5%.

In some embodiments, the polarization function may be realized by adding a polarization film on the infrared band-pass filter. According to the principle of optics, the reflected light of the window on the vehicle has the polarization characteristic, and a polarization direction of the infrared band-pass polarization filter is perpendicular to a polarization direction of the reflected light of the window, which may filter out the reflected light, such as filtering out the sunlight reflected from the window on the vehicle, to make for a clearer image of the interior of the vehicle.

In some embodiments, in response to a determination that the current brightness is less than the first preset threshold, the filter plate of the camera may be switched to the second filter plate. For example, at night, when the current brightness is lower than the first preset threshold, the second filter plate may be the infrared band-pass filter or the all-pass filter. More details regarding the infrared band-pass characteristic and all-pass characteristic of the filter plate (filter) can be found elsewhere in the present disclosure (e.g., the description in connection with FIG. 2 and FIG. 5).

In some embodiments, the second filter plate may be the infrared band-pass filter, and a transmittance of the infrared band-pass filter for the spectrum with the wavelength below 650 nm may be less than or equal to 5%, a transmittance of the infrared band-pass filter for the spectrum with the wavelength of 710 nm-770 nm may be more than 92%, and a transmittance of the infrared band-pass filter for the spectrum with the wavelength of 900 nm or more may be less than or equal to 5%.

In some embodiments, the second filter plate may be an all-pass filter with a transmittance greater than 92% for a spectrum with a wavelength of 400-1100 nm.

In some embodiments, the wavelength of the spectrum emitted by the infrared xenon lamp may be between 710 nm-1000 nm. A proportion of spectral energy of the spectrum with a wavelength of 720 nm-750 nm may be more than 40%.

In some embodiments, an irradiance of the infrared xenon lamp may be adjustable. More details regarding the irradiance of the infrared xenon lamp can be found elsewhere in the present disclosure (e.g., the description in connection with FIG. 2).

In some embodiments, the processor 130 may adjust the irradiance of the infrared xenon lamp according to different capture distances. In some embodiments, different capture distances may correspond to different minimum irradiances. More details regarding the capture distance can be found elsewhere in the present disclosure (e.g., the description in connection with FIG. 2).

In some embodiments of the present disclosure, according to the obtained current brightness, for example, when the vehicle passes through a checkpoint road or an entrance and exit, the filter plate is automatically switched to assist the camera to capture and the infrared xenon lamp to supplement light, which realize all-weather glare-free vehicle image capture and recognition while ensuring the clarity of the captured image, reducing a driving risk of a driver and improving safety. Some embodiments of the present disclosure only need a CMOS or CCD imaging chip to achieve the all-weather glare-free in-vehicle capture manner, without the need for a splitter prism, and the configuration is relatively simple, which reduces production costs.

FIG. 8 is a block diagram of an exemplary processor according to some embodiments of the present disclosure.

As shown in FIG. 8, in some embodiments, the processor 130 may include the first obtaining module 810, the first determination module 820, the first adjustment module 830, the second adjustment module 840, the second obtaining module 850, the third obtaining module 860, and the second determination module 870.

In some embodiments, in response to a first acquisition instruction, the first obtaining module 810 may be configured to obtain at least one image of interior of a vehicle through a filter under a condition of irradiation of an infrared xenon lamp, and the filter may include an infrared band-pass characteristic.

In some embodiments, a difference between a first transmittance and a second transmittance of the filter is greater than 40%, the first transmittance is a transmittance of the filter for light in a first wave band, and the second transmittance is a transmittance of the filter for light in a second wave band.

In some embodiments, the first wave band is below 650 nm or above 900 nm, and the first transmittance is less than or equal to 5%; and the second wave band is between 710 nm-770 nm, and the second transmittance is greater than 45%.

In some embodiments, a proportion of spectral energy emitted by the infrared xenon lamp in a third wave band is greater than 90%, and the third wave band is between 710 nm-1000 nm; and a proportion of the spectral energy emitted by the infrared xenon lamp in a fourth wave band is greater than 40%, and the fourth wave band is between 720 nm-750 nm.

In some embodiments, the filter may also include a polarization characteristic.

The first determination module 820 may be configured to determine a polarization angle of the filter based on at least one of environmental data, data of a window on the vehicle, or polarization data of the filter.

In some embodiments, the first determination module 820 may also be configured to obtain a first image by adjusting, based on the environmental data, the filter to a first polarization angle; obtain a second image by adjusting the filter to a second polarization angle; compare a first clarity of the first image and a second clarity of the second image; and determine the polarization angle of the filter based on the comparison.

In some embodiments, the first adjustment module 830 may be configured to adjust a position of the filter based on the polarization angle.

In some embodiments, the second adjustment module 840 may be configured to adjust a characteristic of the filter based on the environmental data.

In some embodiments, in response to determining that the environmental data does not satisfy a preset condition, the second adjustment module 840 may also be configured to adjust the characteristic of the filter to a first characteristic which includes the infrared band-pass characteristic. In some embodiments, in response to determining that the environmental data satisfies the preset condition, the second adjustment module 840 may also be configured to adjust the characteristic of the filter to a second characteristic which includes the infrared band-pass characteristic and a polarization characteristic.

In some embodiments, in response to a second acquisition instruction, the second obtaining module 850 may be configured to obtain two or more frames of images.

In some embodiments, the third obtaining module 860 may be configured to determine external information of the vehicle based on the two or more frames of images.

In some embodiments, the second determination module 870 may be configured to obtain a plurality of candidate wave bands. For each of the plurality of candidate wave bands, the second determination module 870 may be configured to obtain imaging brightness of a window on the vehicle and imaging brightness of the interior of the vehicle under the candidate wave band; and determine a brightness difference of the candidate wave band between the imaging brightness of the window on the vehicle and the imaging brightness of the interior of the vehicle under the candidate wave band; and determine, based on the brightness differences of the plurality of candidate wave bands, a first wave band and a second wave band of the filter. In some embodiments, a difference between a first transmittance and a second transmittance of the filter is greater than 40%, the first transmittance is a transmittance of the filter for light in the first wave band, and the second transmittance is a transmittance of the filter for light in a second wave band.

It should be noted that, the above descriptions of the device for image acquisition are only for convenience of descriptions, and do not limit the descriptions to the scope of the illustrated embodiments. It may be understood that for those skilled in the art, after understanding the principle of the system, it is possible to combine various modules arbitrarily, or form a subsystem to connect with other modules without departing from this principle.

When the operations performed are described step by step in the embodiments of the present disclosure, unless otherwise specified, the order of the steps may be changed, the steps may be omitted, and other steps may also be included in the operation process.

The embodiments in the present disclosure are only for illustration and description, and do not limit the scope of application of the present disclosure. For those skilled in the art, various modifications and changes that may be made under the guidance of the present disclosure are still within the scope of the present disclosure.

In addition, certain features, structures, or characteristics in one or more embodiments of the present disclosure may be properly combined.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

If there is any inconsistency or conflict between the descriptions, definition, and/or use of terms in the cited materials in the present disclosure and the contents of the present disclosure, the descriptions, definition and/or use of terms in the present disclosure shall prevail.

1. A method for image acquisition, comprising:
in response to a first acquisition instruction, obtaining at least one image of interior of a vehicle through a filter under a condition of irradiation of an infrared xenon lamp, wherein the filter includes an infrared band-pass characteristic.

2. The method of claim 1, wherein a difference between a first transmittance and a second transmittance of the filter is greater than 40%, the first transmittance being a transmittance of the filter for light in a first wave band, and the second transmittance being a transmittance of the filter for light in a second wave band.

3. The method of claim 2, wherein
the first wave band is below 650 nm or above 900 nm, and the first transmittance is less than or equal to 5%; and
the second wave band is between 710 nm-770 nm, and the second transmittance is greater than 45%.

4. The method of claim 1, wherein
a proportion of spectral energy emitted by the infrared xenon lamp in a third wave band is greater than 90%, and the third wave band is between 710 nm-1000 nm; and
a proportion of the spectral energy emitted by the infrared xenon lamp in a fourth wave band is greater than 40%, and the fourth wave band is between 720 nm-750 nm.

5. The method of claim 1, wherein the filter further includes a polarization characteristic.

6. The method of claim 5, further comprising:
determining a polarization angle of the filter based on at least one of environmental data, data of a window on the vehicle, or polarization data of the filter; and
adjusting a position of the filter based on the polarization angle.

7. The method of claim 6, wherein determining the polarization angle of the filter based on at least one of the environmental data, the data of the window on the vehicle, or the polarization data of the filter includes:
obtaining a first image by adjusting, based on the environmental data, the filter to a first polarization angle;
obtaining a second image by adjusting the filter to a second polarization angle;
comparing a first clarity of the first image and a second clarity of the second image; and
determining the polarization angle of the filter based on the comparison.

8. The method of claim 1, further comprising:
adjusting a characteristic of the filter based on environmental data.

9. The method of claim 8, wherein adjusting the characteristic of the filter based on the environmental data includes:
in response to determining that the environmental data does not satisfy a preset condition, adjusting the characteristic of the filter to a first characteristic which includes the infrared band-pass characteristic.

10. The method of claim 1, further comprising:
in response to a second acquisition instruction, obtaining two or more frames of images; and
determining external information of the vehicle based on the two or more frames of images.

11. A method for determining a wave band of a filter, the filter being used for a camera device to obtain at least one image of interior of a vehicle under a condition of irradiation of an infrared xenon lamp, the method comprising:
obtaining a plurality of candidate wave bands;
for each of the plurality of candidate wave bands,
obtaining imaging brightness of a window on the vehicle and imaging brightness of the interior of the vehicle under the candidate wave band; and
determining a brightness difference of the candidate wave band between the imaging brightness of the window on the vehicle and the imaging brightness of the interior of the vehicle under the candidate wave band; and determining, based on the brightness differences of the plurality of candidate wave bands, a first wave band and a second wave band of the filter, wherein a difference between a first transmittance and a second transmittance of the filter is greater than 40%, the first transmittance is a transmittance of the filter for light in the first wave band, and the second transmittance is a transmittance of the filter for light in a second wave band.

12. The method of claim 11, further comprising:
for one of the brightness differences, the brightness difference is determined based on a reflectivity of the window, a transmittance of the window, and a reflectivity of the interior of the vehicle.

13. A system for image acquisition, comprising a filter and a camera device, wherein:
the filter is used for the camera device to obtain at least one image of interior of a vehicle under a condition of irradiation of an infrared xenon lamp; and
the filter includes an infrared band-pass characteristic.

14. The system of claim 13, wherein a difference between a first transmittance and a second transmittance of the filter is greater than 40%, the first transmittance being a transmittance of the filter for light in a first wave band, and the second transmittance being a transmittance of the filter for light in a second wave band.

15. The system of claim 14, wherein
the first wave band is below 650 nm or above 900 nm, and the first transmittance is less than or equal to 5%; and
the second wave band is between 710 nm-770 nm, and the second transmittance is greater than 45%.

16. The system of claim 13, wherein
a proportion of spectral energy emitted by the infrared xenon lamp in a third wave band is greater than 90%, and the third wave band is between 710 nm-1000 nm; and
a proportion of the spectral energy emitted by the infrared xenon lamp in a fourth wave band is greater than 40%, and the fourth wave band is between 720 nm-750 nm.

17. The system of claim 13, wherein the filter further includes a polarization characteristic.

18. The system of claim 17, wherein a position of the filter is adjusted based on a polarization angle of the filter which is determined based on at least one of environmental data, data of a window on the vehicle, or polarization data of the filter.

19. The system of claim 13, wherein a characteristic of the filter is adjusted based on environmental data.

20. (canceled)

21. The method of claim 8, wherein adjusting the characteristic of the filter based on the environmental data includes:
in response to determining that the environmental data satisfies a preset condition, adjusting the characteristic of the filter to a second characteristic which includes the infrared band-pass characteristic and a polarization characteristic.
